(19) United States
(12) Patent Application Publication
(10) Pub. No.: US 2022/0048670 A1
(43) Pub. Date: Feb. 17, 2022

(54) Platform Security System

(71) Applicant: James M. Justitz, San Antonio, TX (US)

(72) Inventor: James M. Justitz, San Antonio, TX (US)

(21) Appl. No.: 17/303,143

(22) Filed: May 21, 2021

Related U.S. Application Data
(60) Provisional application No. 62/706,381, filed on Aug. 13, 2020.

(51) Int. Cl. B65D 19/44; B65D 19/38

(52) U.S. Cl. CPC B65D 19/44; B65D 2519/0081; B65D 19/385

(57) ABSTRACT

The Platform Security System is an apparatus comprised of tamper resistant metal pallet securing clamps design to fit the corners or edges of palletized materials which are connected to and secured to each other across the surface of said palletized materials so as to enable the securing of said palletized materials thereby preventing or resisting the theft of the secured materials.

### FIELD OF THE INVENTION

The subject invention relates generally to security devices, and more particularly to a security device for securing products or product packing devices such as pallets and crates used, for example, in construction material distribution.

This invention relates generally to an Adjustable Pallet Clamp Security System in the form of an adjustable locking apparatus for securing pallets of materials to be stored on a construction site.

### BACKGROUND OF THE DISCLOSURE

Reusable packing and shipping devices such as pallets, crates, trays, boxes, et cetera have been used in the shipping of goods such as construction materials and retail products. Such packing and shipping devices are often left unattended in open areas where they are exposed to theft or damage. Building materials such as lumber are often similarly left exposed in construction areas and are favorite targets of theft and vandalism.

There is a need for a system or apparatus to secure materials packed, shipped, and stored on pallets.

### BRIEF SUMMARY OF THE INVENTION

According to a first aspect of the invention, there is a Security Device for securing a package onto a transportable platform comprising all the features of claim 1. According to another aspect of the invention there is a Transportable Platform Security System comprising all features of claim 2. According to another aspect of the invention there is a Transportable Platform Security System comprising all features of claim 3. Further features of the invention are disclosed in dependent claims.

The Transportable Platform Security System includes of a Security Device for securing pallets of materials to be stored on a construction site, in a warehouse, in a shipping yard, on a trailer, or in another place where packages may be stored. An advantage of the adjustable security device is to enable the securing of construction materials or other goods to the pallets they are packed, shipped, or stored upon so as prevent theft.

Preferably the security device is suitable for securing a package onto a transportable platform, wherein the package includes construction retail goods or other goods which may be transported and stored on a pallet. The security device may comprise these: a post; first and second corner units held an adjustable distance apart by the post, wherein the first corner unit is shaped to receive a corner of a platform; and an operable, lockable press or collar or other adjustment device connected to the post to press the corner units toward each other. The post, the first and/or second corner unit, and the press may be bundled together unassembled as a kit of parts. The corner units may have a convenient stackable shape. For example they may have portion(s) with an L or V shaped cross section.

Preferably the distance between the first and second corner units may be operating the press to urge one of the corner unit toward and/or away from the other.

Preferably the first corner unit and the second corner unit each have an internal corner to receive a two or three sided corner of a pallet and a package. The internal corner may have a shape of the internal corner of an L or V and may be formed by a part with an L or V shaped cross section such as an angle iron or I beam. The material of the corner units may be a metal or alloy or other strong material including but not limited to steel, Kevlar, stainless steel, polymer or ceramic.

Preferably the first corner unit of at least one security device has a two sided internal corner. Preferably the first corner unit of at least one security device has a three sided internal corner. Preferably the second corner unit of at least one security device has a two sided internal corner. Preferably the second corner unit of at least one security device has a three sided internal corner.

Preferably at least one of the security devices of the system has a first corner unit and second corner unit, which both have a three sided internal corner to secure to vertically aligned three side corners of the platform and package.

Preferably at least one of the security devices of the system has a first corner unit comprising two three sided corners joined with a rigid part having a two sided internal corner which is coincident at the distal ends with the three sided corners. Preferably the length of the rigid part is adjustable. The post may be indirectly connected to the three sided corner units by being connected to the rigid part between them. So two adjacent corners of the package or platform may be covered by the one first corner unit to provide additional security.

The invention will now be described, by way of example only, with reference to the accompanying drawings in which

### BRIEF DESCRIPTION OF THE FIGURES

The broken lines shown in the figures are for the purpose of illustrating the pallet being secured by the apparatus of the present invention and they form no part of the apparatus but represent the construction materials or retail good to be secured with the present invention.

FIG. 1 is a three-dimensional perspective view of a first security device;

FIG. 2 is a three-dimensional perspective view of a package on a platform;

FIG. 3 is a three-dimensional perspective view of a covered package on a platform secured with corner-unit style units of a security system shown on all eight corners of said covered package on the platform;

### DETAILED DESCRIPTION OF THE INVENTION

The detailed embodiments of the present invention are disclosed herein. The disclosed embodiments are merely exemplary of the invention, which may be embodied in various forms. The details disclosed herein are not to be interpreted as limiting, but merely as the basis for the claims and as a basis for teaching one skilled in the art how to make and use the invention.

References in the specification to “one embodiment,” “an embodiment,” “an example embodiment,” et cetera indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

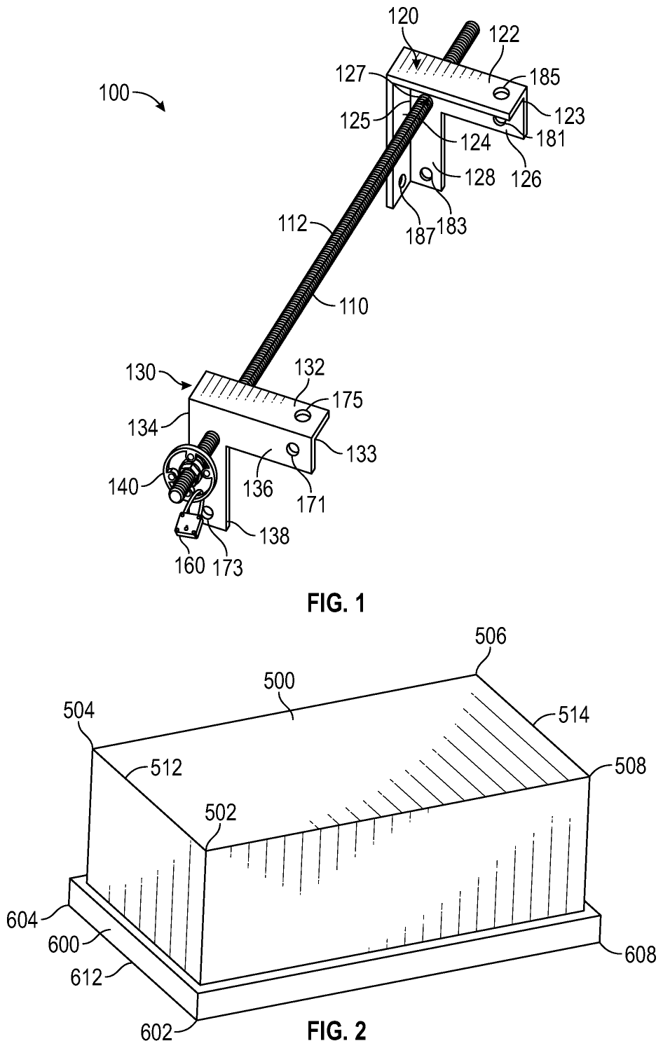

Referring to the Figures, there is shown in FIG. 1, a security device 100 for securing a package 500 onto a platform 600. In FIG. 2, there is an illustration of the package 500 and the platform 600. The package 500 rests on the platform 600 and may be freely lifted off the platform 600.

Industries such as the construction industry, the agricultural and food production industry, industrial factory industries, and even individuals often use a transportable platform such as a pallet. The platform 600 shown in FIG. 2 could be a pallet. The package 500 shown in FIG. 2 could be an item or items stored on the pallet 600.

The transportable platform 600 is plate-like or comprises a ledge having a perimeter edge 612. The perimeter edge 612 of the ledge is where a perimeter side of platform meets an underside of the platform or ledge. There is a corner where the sides meet, although it need not be a sharp corner.

The platform 600 is shown as four sided, although it is not essential for the platform 600 to have four sides. The platform has four corners 602, 604, 606, 608. Three edges of the platform 600 converge to each corner. At each of these four corners, two perimeter sides meet the underside of the platform 600 or ledge of the platform.

The package 500 is illustrated in FIG. 2 as block-like in shape although this is not necessary. The package 500 may be a crate to store items. It may be a stack of boards. It may be a collection of things.

The package 500 has top corners 502, 504, 506, 508 where two perimeter sides of the package meet a top side of the package 500. The top side is distal from the platform 600. Each top corner of the package 502, 504, 506, 508 is vertically above a respective corner 602, 604, 606, 608 where the underside of the platform meets two perimeter sides of the platform. A post 110 could extend from a corner 602, 604, 608 of the platform and could extend orthogonal to the platform top on which the package500 rests so that the post extends vertically upward. This post could thus go straight up vertically from the corner 602, 604, 608 at the underside of the platform to the respective corner 502, 504, 506, 508 at the top of the package 500.

The security device 100 shown in FIG. 1 has a post 110 arranged to extend from one of the corners 602, 604, 608 at the underside of the platform to the respective corner 502, 504, 506, 508 at the top of the package 500.

The security device 100 comprises two corner units: a first corner unit 120 and a second corner unit 130. The post 110 holds the corner units 120, 130. The first corner unit 120 is arranged to move along the post 110 and/or the second corner unit 130 is arranged to move along the post so that the distance of separation between the two corner units 120, 130, may be adjusted to the distance between respective corners of the platform 600 and package 500, such as for example the distance between corner 602 at the underside of the platform 600 and the corner 502 of the package 500 which is vertically above.

The post 110 has along it threads or notches for a nut or a pawl of a ratchet. Thus the two corner units 120, 130 may be urged closer together by a ratchet or a security collar with a tightening nut 140 on the post . The second corner unit 130 is intermediate first corner unit 120 the security collar with tightening nut 140. So as the security collar with tightening nut 140 is turned on the threads of the post 110, the security collar with tightening nut 140 presses the second corner unit 130 toward first corner unit 120.

The security collar with tightening nut 140 has an aperture to receive a shank of a padlock 160 to prevent the security collar with tightening nut 140 from being turned on the post 110. This prevents unauthorized increase in separation distance between the first and second corner units 120, 130. The first or second corner unit 120, 130 may have a through hole 173, 183 such as shown in FIG. 1 to receive the shank of the padlock 160. The security collar with tightening nut 140 may then be locked to the first 120 or second corner unit 130 to prevent the unauthorized increase in separation distance.

The first corner unit 120 or the second corner unit 130, but not both, may be fixed to the post 110, while the other non-fixed corner unit 120, 130 is movable and adjustable distance and may be urged closer to the fixed corner unit 120, 130 by the security collar with tightening nut 140.

The first corner unit 120 and/or the second corner unit 130 have an unthreaded through hole through which post 110 passes through. The through hole diameter may have a slip fit tolerance with the diameter of the post 110. This prevents the first and/or the second corner unit 120, 130 from wobbling on the post 110.

The post 110 may have a spine 112 or groove extending axially on the exterior to receiving corresponding groove 127 or spine in the first corner unit 120 and/or the second corner unit 120. The spine 112 engages the groove to prevent the first corner unit 120 and/or the second corner unit 130 from turning around the axis of the post 110.

So the first and second corner units 120, 130 are held in fixed orientation an adjustable distance apart by post 110.

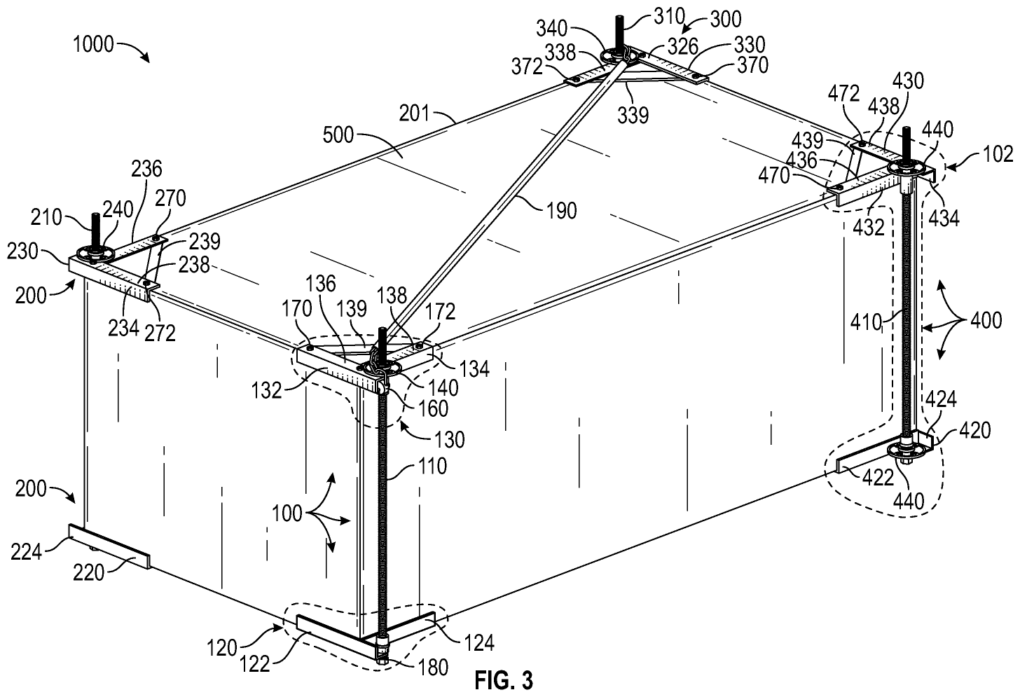

As shown in FIG. 3, first security device 100 secures a covered package 500 to a pallet 600. The first corner unit 120 engages the underside corner 602 of the platform 600. The second corner unit 130 engages the corresponding top corner 502 of the package 500. The post 110 holds the two corner units 120, 130 so that they are held in fixed orientation an adjustable distance apart. The security collar with tightening nut 140 presses the second corner unit 130 toward the first corner 120. In this way, the first corner unit 120 urges the platform 600 against the package 500 and the second corner unit 130 urges the package 500 against the platform. The first security device 100 clamps the package 500 and platform 600 together intermediate the first corner unit 120 and the second corner unit 130. The post 110 holds corner units 120, 130 in fixed orientation so that they cannot be easily twisted or turned off the package 500 or the platform.

The first corner unit 120 has a first side brace 122 and a second side brace 124 which abut against respective perimeter sides of the platform 600 which converge to the corner 602 of the platform. The first corner unit 120 has a third side brace 126 and a fourth side brace 128 which abuts against the underside of the platform 600.

The first side brace 122 and the third side brace 126 converge to an internal corner 123 which receive a corner of the platform 600 formed by a perimeter side and the underside. The second side brace 124 and the fourth side brace 128 converge to an internal corner 125 which receive a corner of the platform 600 formed by a perimeter of an adjacent side and the underside. So the first corner unit 120 has an internal corner 123, 125 which receives the external corner 602 of the platform 600 where three sides converge. This makes it difficult for the first corner unit 120, and therefore the first security device 100, to be removed from the platform 600 when the corner 602 is clamped in the first corner unit 120.

The second corner unit 130 also has a first 132 and third side brace 136 which converge to an internal corner 133 in the same fashion as the first corner unit 120. Also the second corner unit 130 has a second 134 and third side brace 138 which converge to an internal corner 133 in the same fashion the first corner unit 120. So the second corner unit 133 internal corner receives the corresponding external corner 502 of the package 500. The first and second side braces 132, 134 abut against perimeter sides of the package 500 which converge to an external corner 502. The third 136 and fourth 138 side braces abut against the top side the package 500. So the external corner 502 of package is clamped into internal corner 133 the second corner unit 130. So it is difficult for the second corner unit 130, and therefore the first security device 100 to be removed from the platform 500 when the corner 502 is clamped in the second corner unit 130.

The side braces pairs 122, 124 , 126, 128; 132, 134, 136; and 138 may each be made from an “angle iron” or other L cross section part or extrusion which may comprise an alloy, ceramic or polymer which is resistant to cutting or deforming.

As shown in FIG. 3, there is also a second security device 200, a third security device 300, and a fourth security device 400. Each of these security devices 200, 300, 400 is of the same type as the first security device 100 also comprising a post, first corner unit, second corner unit, security collar with tightening nut or ratchet, and lock to prevent unauthorized removal of the second, third and fourth security devices from corresponding corners of the platform 600 and package 500.

A cross bar 190 over the package 500 is connected to the first security device 100 and third security device 300 at diagonally opposite corners of the package 500 to provide additional security of holding the package 500 against the platform. The cross bar 190 is connected to the posts 110, 310 and/or the second corner units 130, 330.

In a preferred embodiment, there is a security device for securing a package onto a transportable platform 600, comprising a post 110, first 120 and second corner 130 units held an adjustable distance apart by the post, wherein the first corner unit 120 is shaped to receive a corner of a platform 602,604,606,608; and an operable, lockable press connected to the post to press the corner units toward each other.

In a preferred embodiment, there is a kit of parts for assembling a platform clamp, comprising a first corner unit 120 and a second corner unit 130, wherein the first corner unit is shaped to receive a corner of a platform 600, a post arranged to hold the corner units an adjustable distance apart; and an operable, lockable press connectable to the post to press the corner units toward each other.

In a preferred embodiment, there is a transportable platform security system for securing a package 500, comprising a platform 600, and first 100 and second security devices 200 each one of the security devices having a first corner unit 120, 220 wherein is received a respective corner of the platform 600, a second corner unit 130,230 shaped to receive a respective corner of the package 500, a post arranged to hold the first and second corner units an adjustable distance apart, and an operable, lockable press connected to the post 110,210 to compress the package intermediate the first and second corner units.

In an alternate embodiment, there is a transportable platform security system for securing a package 500 wherein the press is arranged to press the second corner unit 130 toward the first corner unit 120.

In an alternate embodiment, there is a transportable platform security system for securing a package 500 wherein the first corner unit 120, 220, 320, 420; of each security device supports the post of the respective security device orthogonal to the platform.

In an alternate embodiment, there is a transportable platform security system for securing a package wherein an internal corner is formed in each of the first corner units 120, 220, 320,420 to receive the respective corner of each platform 600 and has two or three sides convergent to a vertex wherein the sides are orthogonal, and one or two connected angle irons form the two or three sides respectively, wherein a portion of the first corner unit with an L shaped cross section is oriented with its internal 123, 223, 323, 423 corner to receive the respective corner of the platform.

In an alternate embodiment, there is a transportable platform security system for securing a package500 wherein an internal corner 123, 133 is formed in each of the first corner units 120 to receive the respective corner of each platform 600.

In an alternate embodiment, there is a transportable platform security system for securing a package 500 wherein the press is turn-able about a thread on the post to adjust the separation distance between the first 120 and second corner units 130 each security device.

In an alternate embodiment, there is a transportable platform security system for securing a package 500 wherein the first corner unit of each of the first and second security devices is received 120, 220 in respective corners of the platform 600 which are diagonally opposite each other.

In an alternate embodiment, there is a transportable platform security system for securing a package 500 comprising a cable or chain 190 connected across the platform to each of the second corner units 130, 230.

In an alternate embodiment, there is a transportable platform security system for securing a package 500 wherein the press is lockable to the second corner unit 130 or to the post 110 to fix the distance between the first 120 and second corner units 130.

In an alternate embodiment, there is a transportable platform security system for securing a package 500 wherein the post 110 comprises an all-thread rod 112.

In an alternate embodiment, there is a transportable platform security system for securing a package 500 wherein the post 110 is through the first 120 and second 130 corner units.

In an alternate embodiment, there is a transportable platform security system for securing a package 500 wherein the post fits together with the first 120 and second corner 130 units to hold them in fixed orientation.

In an alternate embodiment, there is a transportable platform security system for securing a package 500 wherein the second corner unit 130 is intermediate the first corner unit 120 and the press.

In an alternate embodiment, there is a transportable platform security system for securing a package 500 wherein a first hole through 183 the first corner unit 120 is unthreaded for a screw fastener pass through to fasten the first corner unit to the platform 600.

In an alternate embodiment, there is a transportable platform security system for securing a package 500 wherein a pallet comprises the platform 600 and the transportable platform comprises the pallet.

In an alternate embodiment, there is a transportable platform security system for securing a package 500 wherein the first 120 and second corner 130 units are substantially the same.

In an alternate embodiment, there is a transportable platform security system for securing a package 500 comprising at least a third security device 300 arranged at a respective corner of the platform in the manner of the first 100 and second 200 security devices.

In an alternate embodiment, there is a transportable platform security system for securing a package 500 comprising four security devices,100, 200, 300, 400 each one arranged as the first and second security devices at a respective corner the platform which is rectangular with four corners.

A security device for securing a package onto a transportable platform, comprising a post 110 , first and second edge units 120, 130 held an adjustable distance apart by the post, wherein the first edge unit 120 is shaped to receive an edge of a platform 600, and an operable, lockable press connected to the post to press the edge units toward each other.

A kit of parts for assembling a platform clamp, comprising first edge unit and second edge unit 120,130 wherein the first edge unit 120 is shaped to receive an edge of a platform 600, a post 110 arranged to hold the edge units an adjustable distance apart, and an operable, lockable press connectable to the post to press the edge units toward each other.

The invention has been described by way of examples only. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claims.

### INDEX OF LABELLED FEATURES IN FIGURES

Secured Covered Pallet of Construction Materials (Type 1) . . . 1000
First Security Device . . . 100
Post, first security device . . . 110
Spine or Groove in post . . . 112
First Corner Unit (type 1), first security device . . . 120
First Side Brace, first corner unit . . . 122
Internal Corner, first corner unit . . . 123
Second Side Brace, first corner unit . . . 124
Internal Corner, first corner unit . . . 125
Third Side Brace, first corner unit . . . 126
Groove in third side brace, first corner unit . . . 127
Fourth Side Brace, first corner unit . . . 128
Second Corner Unit (type 1), first security device . . . 130
First Side Brace, second corner unit . . . 132
Internal Corner, second corner unit . . . 133
Second Side Brace, second corner unit . . . 134
Third Side Brace, second corner unit . . . 136
Fourth Side Brace, second corner unit . . . 138
Tie for third and fourth side brace, second corner unit . . . 139
Security Collar with Tightening Nut . . . 140
Padlock . . . 160
First Fastener . . . 170
Second Fastener . . . 172
Second Fastener . . . 172
Through-hole . . . 171, 173, 175, 181,183, 185, 187
Cross Bar . . . 190
Second Security Device . . . 200
Post, second security device . . . 210
First Corner Unit (type 1), second security device . . . 220
Second Side Brace, first corner unit . . . 224
Second Corner Unit (type 1), first security device . . . 230
Second Side Brace, second corner unit . . . 234
Third Side Brace, second corner unit . . . 236
Fourth Side Brace, second corner unit . . . 238
Tie for third and fourth side brace, second corner unit . . . 239
First Fastener . . . 270
Second Fastener . . . 272
Third Security Device . . . 300
Post, third security device . . . 310
Second Corner Unit (type 1), third security device . . . 330
Third Side Brace, second corner unit . . . 336
Fourth Side Brace, second corner unit . . . 338
Tie for third and fourth side brace, second corner unit . . . 339
First Fastener . . . 370
Second Fastener . . . 372
Fourth Security Device . . . 400
Post, fourth security device . . . 410
First Corner Unit (type 1), fourth security device . . . 420
First Side Brace, first corner unit . . . 422
Second Side Brace, first corner unit . . . 424
Second Corner Unit (type 1), fourth security device . . . 430
First Side Brace, second corner unit . . . 432
Second Side Brace, second corner unit . . . 434
Third Side Brace, second corner unit . . . 436
Fourth Side Brace, second corner unit . . . 438
Tie for third and fourth side brace, second corner unit . . . 439
Security Collar with Tightening Nut . . . 440
Padlock . . . 460
First Fastener . . . 470
Second Fastener . . . 472
Package . . . 500
First Corner of Package . . . 502
Second Corner of Package . . . 504
Third Corner of Package . . . 506
Fourth Corner of Package . . . 508
First Edge of Package . . . 512
Second Edge of Package . . . 514
Platform . . . 600
First Corner of Platform . . . 602
Second Corner of Platform . . . 604
Third Corner of Platform . . . 606
Fourth Corner of Platform . . . 608
First Edge of Platform . . . 612
Tie for third and fourth side brace, second corner unit . . . 139
Security Collar with Tightening Nut . . . 140
Padlock . . . 160
First Fastener . . . 170
Second Fastener . . . 172
Cross Bar . . . 192

1. A security device for securing a package onto a transportable platform, comprising a post, a first corner unit and a second corner unit held an adjustable distance apart by said post, wherein said first corner unit is shaped to receive a corner of a platform, and an operable and lockable press connected to said post to press said first corner unit and said second corner unit toward each other.

2. A kit of parts for assembling a platform clamp, comprising first corner unit and a second corner unit, wherein said first corner unit is shaped to receive a corner of a platform, a post arranged to hold said first corner unit and said second corner unit an adjustable distance apart, and an operable and lockable press connectable to said post to press said first corner unit and said second corner unit toward each other.

3. A transportable platform security system for securing a package, comprising a platform, and a first security device and a second security device each one of the security devices having a first corner unit wherein is received a respective corner of said platform, a second corner unit shaped to receive a respective corner of said package, a post arranged to hold said first corner unit and said second corner unit an adjustable distance apart, and an operable and lockable press connected to said post to compress said package intermediate said first corner unit and said second corner unit.

4. The transportable platform security system according to claim 3, wherein said press is arranged to press said second corner unit toward said first corner unit.

5. The transportable platform security system according to claim 3 wherein said first corner unit of each security device supports said post of the respective security device orthogonal to the platform.

6. The transportable platform security system according to claim 3 wherein an internal corner is formed in each of the first corner units to receive the respective corner of each platform and has two or three sides convergent to a vertex wherein said sides are orthogonal, and one or two connected angle irons form said two or three sides respectively, wherein a portion of said first corner unit having an L-shaped cross section is oriented with its internal corner to receive the respective corner of said platform.

7. The transportable platform security system according to claim 3 wherein an internal corner is formed in each of said first corner units to receive the respective corner of each platform.

8. The transportable platform security system according to claim 3 wherein the press is turn-able about a thread on the post to adjust said separation distance between said first corner unit and said second corner unit of each security device.

9. The transportable platform according to claim 3 wherein said first corner unit of each of said first security device and said second security device is received in respective corners of the platform which are diagonally opposite each other.

10. The transportable platform security system according to claim 3 comprising a cable or chain connected across said platform to each of the second corner units.

11. The transportable platform security system according to claim 3 wherein the press is lockable to said second corner unit or to said post to fix a distance between said first corner unit and said second corner unit.

12. The transportable platform security system according to claim 3 wherein said post comprises an all-thread rod.

13. The transportable platform security system according to claim 3 wherein said post is through said first corner unit and said second corner unit.

14. The transportable platform security system according to claim 3 wherein said post fits together with said first corner unit and said second corner unit to hold them in fixed orientation.

15. The transportable platform security system according to claim 3 wherein the second corner unit is intermediate the first corner unit and the press.

16. The transportable platform security system according to claim 3 wherein a first hole through the first corner unit is unthreaded for a screw fastener pass through to fasten said first corner unit to said platform.

17. The transportable platform security system according to claim 3 wherein a pallet comprises said platform and said transportable platform comprises the pallet.

18. The transportable platform security system according to claim 3 comprising at least a third security device arranged at a respective corner of the platform in the manner of the first and second security devices.

19. The transportable platform security system according to claim 3 comprising four security devices, each one arranged as the first and second security devices at a respective corner the platform which is rectangular with four corners.
